(19) United States
(12) Patent Application Publication
(10) Pub. No.: US 2010/0253844 A1
(43) Pub. Date: Oct. 7, 2010

(54) ESTABLISHING TV INPUT AT POWER-ON

(75) Inventors: David Penic, San Diego, CA (US); Roy Steward, Poway, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/416,382

(22) Filed: Apr. 1, 2009

(51) Int. Cl. H04N 3/27

(52) U.S. Cl. 348/554; 348/E03.049

(57) ABSTRACT

A TV presents a user interface (UI) to allow a user to select which one of plural input sources is to able used as the source of content to be presented on the TV at TV power-on.

### FIELD OF THE INVENTION

The present invention relates generally to establishing which one of plural inputs to a TV will be used to present programming on the TV at TV power-on.

### BACKGROUND OF THE INVENTION

The venerable “rabbit ears” TV antennas have become a rarity on the modern TV, which instead typically receives cable TV signals and/or satellite TV signals and/or recorded content from sources such as, e.g., digital video recorders (DVR) and digital video disk (DVD) players through a receiver broadly referred to as a “set top box” (STB). A type of STB is the so-called “set back box” (SBB) which differs from a STB chiefly by being controlled by the same remote control that controls the TV.

Regardless of what input source had been the source of content presented on the TV at power off, after subsequent power on the TV automatically reverts to using a predetermined source, such as the tuner or set-top box, as the input to the TV. The user is unable to define a different power-on source than what is imposed by the TV manufacturer.

### SUMMARY OF THE INVENTION

Accordingly, present principles allow the user to program any desired input to be the primary setting on initial power on regardless of which input was used when the set was turned off.

A TV includes TV processor configured to communicate with plural input sources of content, and a computer readable storage medium accessible to the processor. A TV display is controlled by the processor to present content from an input source. The processor automatically causes, at power-on of the TV, content from a user-selected one of the input sources to be presented on the display.

In some embodiments the processor causes a user interface (UI) to be presented on the display listing the input sources. The processor may store in memory one of the input sources as a power-on source responsive to a user input selection from the UI. If desired, the UI can prompt for a power-on source selection.

If a user-selected power-on input source is deenergized at TV power-on, the TV processor can send a control signal to the user-selected power-on input source to energize it. Or, if a user-selected power-on input source is unavailable at TV power-on, the TV processor may present content from a manufacturer-defined default source on the TV display. Yet again, if a user-selected power-on input source is unavailable at TV power-on, the TV processor can present content from a user-selected backup source.

In another aspect, a TV presents a user interface (UI) to allow a user to select which one of plural input sources is to be used as the source of content to be presented on the TV at TV power-on.

In another aspect, a system has a video display, a user input device, plural input sources of video content for the display, and a processor presenting on the display a list of the sources. The processor receives a selection of at least one selected source on the list as indicated by a signal from the input device. The selected source is always used as a power-on source of content to the display at subsequent power-ons until such time as another source is selected as a power-on source.

The details of the present invention, both as to its structure and operation, can best be understood in reference to the accompanying drawings, in which like reference numerals refer to like parts, and in which.

### BRIEF DESCRIPTION OF THE DRAWINGS

FIG. 1 is a block diagram of an example system in accordance with present principles, schematically showing various internal components;

FIG. 2 is a screen shot of an user interface (UI) for allowing the user to select the power-on input source; and

FIG. 3 illustrates example logic.

### DETAILED DESCRIPTION OF THE PREFERRED EMBODIMENT

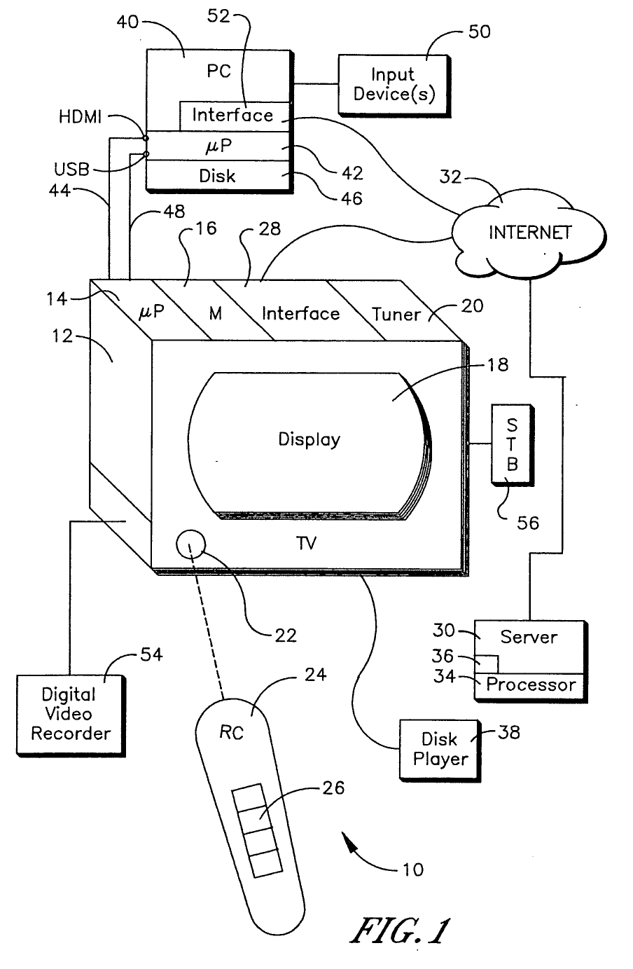

Referring initially to FIG. 1, a system is shown, generally designated 10, which includes a TV 12 having a TV processor 14 accessing a computer readable storage medium 16 such as but not limited to non-volatile solid state storage and/or disk based storage to present TV signals on a TV display 18, such as a flat panel LCD display or other type of matrix display or a plasma display or other suitable type of TV display. The signals are received through a TV tuner 20 that communicate with a suitable source of TV signals. The TV 12 typically includes a wireless receiver 22 such as an infrared receiver for receiving user command signals from a remote control 24. The remote control 24 typically includes one or more manipulable input elements 26 such as keys for enabling a user to input commands to the TV processor 14.

As shown in FIG. 1, the TV 12 may also include a network interface 28 such as but not limited to a wired or wireless modem for enabling the TV processor 14 to communicate with one or more servers 30 over a wide area network such as the Internet 32. The network interface 28 may be incorporated within the chassis of the TV 12 or it may be included in a set-top box or set-back box operably engaged with the TV 12. In any case, the server 30 includes one or more server processors 34 accessing a server data storage medium 36.

An optical disk player 38 may also communicate with the TV processor 14 using HDMI as well as a universal serial bus (USB) link for control. Furthermore, a personal computer 40 can communicate with the TV processor. With more specificity, a PC processor 42 may communicate with the TV processor 14 using a HDMI link 44, over which multimedia data from, e.g., an optical disk player 46 in the PC 40 may be conveyed for display on the TV, as well as a USB link 48, over which control signals between the TV processor and the PC processor may be conveyed.

One or more input devices 50 such as wired or wireless keyboards, mice, etc. may be provided to the PC. Also, in addition to or in lieu of the TV communicating with the Internet 32, the PC 40 may have a network interface 52 communicating with the Internet.

It may readily be appreciated that the TV may receive input of content for display on the TV from any one of the PC 40, disk player 38, and server 30, as well as from the tuner 20. Other examples of content input sources can include a digital video recorder (DVR) 54 which may be a stand alone device or which may be incorporated in a set-top box 56. In general, the TV can receive input from at least two sources, non-limiting examples of which are intended to be conveyed by FIG. 1.

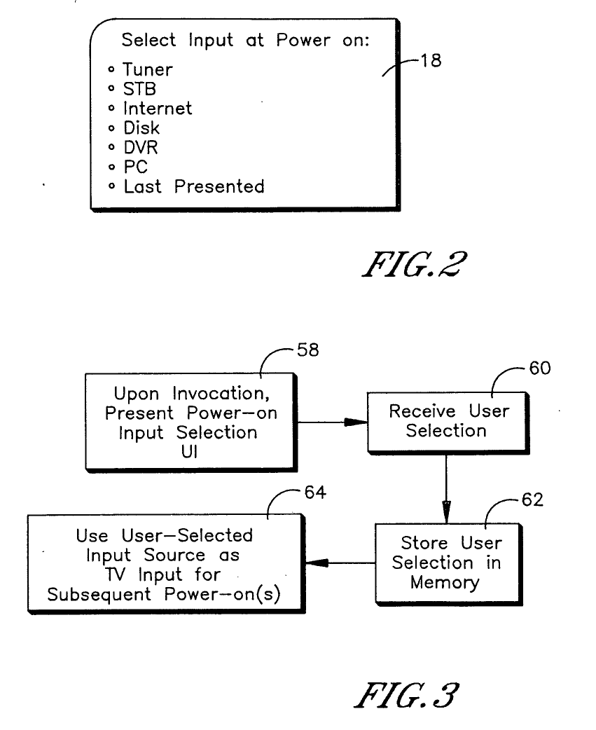

FIG. 2 shows a screen shot of a user interface (UI) that may be presented on the TV display 18 to enable a user to select which input source will be the power-on input source. The UI of FIG. 2 may be accessed from a higher level “setup” screen of the TV.

In the non-limiting example shown, the user is given the option to select from among the example sources shown in FIG. 1 as well as to select the “last” source, i.e., the source from which content was presented on the TV at TV power down.

FIG. 3 shows the logic attendant to FIG. 2 as may be executed by, e.g., the TV processor 14. Commencing at block 58, when the user invokes it from. e.g., a setup menu on the TV, the power on input select UI, of which FIG. 2 is one example, is presented on the TV display 18, prompting the user to select a power on source from among the sources listed. The user may select a source by appropriately manipulating the RC 24, and at block 60 the user selection is received. The selection may be stored in non-volatile memory such as the memory 16 at block 62.

At block 64, during subsequent TV power-ons the user-selected input source is automatically switched to by the TV processor 14 as the input source for the TV without further user intervention. In the event that the user-selected power-on input is deenergized, the TV processor 14 may send a control signal to the source to energize it, or the TV processor may revert to a default back up source, e.g. the TV tuner 20.

In yet another embodiment the user may be given the option of ranking the sources shown in FIG. 2 by order of preference or otherwise identifying a backup power-on input source. For example, a top-ranked input source can be automatically, selected as the power-on source for subsequent power-ons if it is available, with a second-ranked source being automatically selected for input if the first source is unavailable, and so on.

While the particular ESTABLISHING TV INPUT AT POWER-ON is herein shown and described in detail, it is to be understood that the subject matter which is encompassed by the present invention is limited only by the claims.

What is claimed is:

1. TV comprising:
TV processor configured to communicate with plural input sources of content;
computer readable storage medium accessible to the processor; and
TV display controlled by the processor to present content from an input source;
the processor automatically causing, at power-on of the TV, content from a user-selected one of the input sources to be presented on the display.

2. The TV of claim 1, wherein the processor causes a user interface (UI) to be presented on the display listing the input sources.

3. The TV of claim 2, wherein the processor stores in memory one of the input sources as a power-on source responsive to a user input selection from the UI.

4. The TV of claim 2, wherein the UI prompts for a power-on source selection.

5. The TV of claim 1, wherein if a user-selected power-on input source is deenergized at TV power-on, the TV processor sends a control signal to the user-selected power-on input source to energize it.

6. The TV of claim 1, wherein if a user-selected power-on input source is unavailable at TV power-on, the TV processor presents content from a default source on the TV display.

7. The TV of claim 1, wherein if a user-selected power-on input source is unavailable at TV power-on, the TV processor presents content from a user-selected backup source.

8. A TV presenting a user interface (UI) to allow a user to select which one of plural input sources is to be used as the source of content to be presented on the TV at TV power-on.

9. The TV of claim 8, comprising:
TV processor configured to communicate with plural input sources of content;
computer readable storage medium accessible to the processor; and
TV display controlled by the processor to present content from an input source;
the processor automatically causing, at power-on of the TV, content from a user-selected one of the input sources to be presented on the display.

10. The TV of claim 8, wherein the UI lists the input sources.

11. The TV of claim 10, wherein the processor stores in memory one of the input sources as a power-on source responsive to a user input selection from the UI.

12. The TV of claim 8, wherein the UI prompts for a power-on source selection.

13. The TV of claim 8, wherein if a user-selected power-on input source is deenergized at TV power-on, the TV sends a control signal to the user-selected power-on input source to energize it.

14. The TV of claim 8, wherein if a user-selected power-on input source is unavailable at TV power-on, the TV presents content from a default source on the TV display.

15. The TV of claim 8, wherein if a user-selected power-on input source is unavailable at TV power-on, the TV presents content from a user-selected backup source.

16. System comprising:
video display;
user input device;
plural input sources of video content for the display; and
processor presenting on the display a list of the sources and receiving a selection of at least one selected source on the list as indicated by a signal from the input device, the selected source always being used as a power-on source of content to the display at subsequent power-ons until such time as another source is selected as a power-on source.

17. The system of claim 16, wherein the processor stores in memory the selected source.

18. The system of claim 16, wherein if a user-selected power-on input source is deenergized at display power-on, the processor sends a control signal to the user-selected power-on input source to energize it.

19. The system of claim 16, wherein if a user-selected power-on input source is unavailable at display power-on, the display presents content from a default source on the TV display.

20. The system of claim 16, wherein if a user-selected power-on input source is unavailable at display power-on, the processor presents content from a user-selected backup source.
